(19) United States
(12) Patent Application Publication
(10) Pub. No.: US 2006/0145848 A1
(43) Pub. Date: Jul. 6, 2006

(54) Electronic security device and system for articles of merchandise

(75) Inventors: Ronald M. Marsilio, Lake Wiley, SC (US); Dennis D. Belden JR., Waxhaw, NC (US); Christopher J. Fawcett, Charlotte, NC (US); Ian R. Scott, Duluth, GA (US)

Correspondence Address: SAND & SEBOLT, AEGIS TOWER, SUITE 1100, 4940 MUNSON STREET, NW, CANTON, OH, 44718-3615, US

(73) Assignee: Alpha Security Products, Inc., Charlotte, NC (US)

(21) Appl. No.: 11/312,266

(22) Filed: Dec. 20, 2005

Related U.S. Application Data
(60) Provisional application No. 60/639,770, filed on Dec. 28, 2004.

(51) Int. Cl. G08B 13/14

(52) U.S. Cl. 340/568.2; 340/572.1

(57) ABSTRACT

A security device includes a mechanism for attaching the security device to an article of merchandise. A circuit module containing a central controller is contained in the security device and monitors the attachment mechanism to sound an audible alarm contained in the security device if the integrity of a sense loop in the attachment mechanism is compromised. A trigger circuit also actuates the audible alarm if the security device approaches the vicinity of a remote security gate. An EAS tag contained in the security device actuates a security gate alarm upon the unauthorized passage of the article of merchandise through the gate. Other sense loops will actuate the audible alarm through the central controller if a switch within the security device is actuated or when an unlocking mechanism or verification device is used on the security device.

### CROSS REFERENCE TO RELATED APPLICATIONS

This application claims priority from U.S. Provisional Application Ser. No. 60/639,770 filed Dec. 28, 2004; the disclosure of which is incorporated herein by reference.

### BACKGROUND OF THE INVENTION

1. Technical Field

The invention relates to electronic security devices and security systems, and in particular, to a security device for attachment to articles of merchandise to prevent unauthorized removal of the merchandise from a protected environment. More particularly, the invention relates to such a device attached to an article of merchandise which sounds an alarm contained in the device if removed from the merchandise, which will sound the alarm upon the device approaching a security gate, and will actuate a security gate alarm if not inactivated before exiting the protected environment.

2. Background Information

Various retail establishments use numerous types of theft deterrent devices and systems to discourage shoplifting. One common theft deterrent system uses electronic article surveillance tags (EAS) attached to the items of merchandise. These EAS tags are configured to activate an alarm at a security gate that is positioned usually at the exit of the establishment, if the merchandise containing the EAS tag passes through the secured gate before being removed or inactivated at a checkout station. Other security devices contain an internal alarm which activates an audible alarm within the device if an item of merchandise containing an EAS tag is attempted to be removed from the device illegally. Although these various security devices perform satisfactory for their intended purpose, they will only sound their self-contained alarm if a sense loop, such as a cable attached to the merchandise, is compromised, but will not sound if the merchandise containing the security device is removed until the merchandise and attached security device passes in an unauthorized manner through a security gate. This action then will actuate the security gate alarm but not the self-contained alarm of the security device attached to the merchandise. Thus, a thief can remove merchandise containing the secured EAS tag and remain undetected until passing through a store's security gate which will sound an alarm within the store. The thief after running through the security gate can easily disappear in a crowded parking lot or outside environment and escape with the stolen merchandise with the establishment only knowing that an article of merchandise has been removed unlawfully from the premises. These security gate alarm systems also have sensitivity problems due to the great number of EAS tags on all the different types of merchandise. This requires the security gate alarm to be activated at a particular sensitivity level and an unlawful EAS tag may not be sensed at all times.

Thus, the need exists for an improved security device and security system which will provide multiple alarms to assist in deterring the theft of articles of merchandise by sounding an alarm contained in the security device if the security device is removed from the article of merchandise, will sound the self-contained alarm if the secured merchandise approaches a security gate without having been removed from the article of merchandise, and which will work in combination with a security gate of a protected establishment to sound the security gate alarm remote from the security device on the merchandise, if the protected merchandise passes through the gate in an unauthorized manner.

### BRIEF SUMMARY OF THE INVENTION

One aspect of the invention is providing an improved electronic security device and system in which the device is easily attached in a secured condition to various articles of merchandise by various types of attachment mechanisms, such as cable wraps, garment tags, display assemblies, cable loops, etc.

Another aspect of the invention is to provide such a security device and system which will sense if the integrity of one or more sense loops is compromised, which will indicate tampering or removal of the security device from the article of merchandise by sounding an alarm contained within the security device.

A further feature of the invention is to provide such a security device having a self-contained audible alarm which is actuated when the device is in proximity to a security gate or other type of detection station even when the device has not been tampered with and remains on the article of merchandise, and which will continue to sound the alarm even upon removal of the stolen merchandise from the protected establishment.

A still further feature of the invention is to provide the security device with an EAS tag which will activate a security gate alarm system either through RF or magnetic interaction therewith, independently of the self-contained alarm in the security device.

A further aspect of the invention is to provide such a security device which has a blinking LED to provide a theft deterrent by indicating to a potential shoplifter that a security device is on the article of merchandise and is armed.

Another aspect of the invention is to provide the security device with its own self-contained power source such as a inexpensive battery, which provides a relatively long life to the device and which is protected within the device from unlawful damage or inactivation.

Still another feature of the invention is to provide a secure manner of disarming and safely removing the security device from the protected merchandise, without damaging the merchandise or falsely triggering the various audible alarms.

### BRIEF DESCRIPTION OF THE SEVERAL VIEWS OF THE DRAWINGS

A preferred embodiment of the invention, illustrative of the best mode in which applicant contemplates applying the principle, is set forth in the following description and is shown in the drawings and is particularly and distinctly pointed out and set forth in the appended claims.

FIG. 1 is a block diagram of the security system of the present invention.

FIG. 2 is a block diagram of the security device.

FIGS. 3A and 3B is an electrical schematic of the security device of FIG. 2.

FIG. 4 is a diagrammatic perspective view of a merchandise display system in which the security device can be incorporated.

FIG. 5 is a plan view of a garment tag in which the security device can be incorporated.

FIG. 6 is a diagrammatic perspective view of a cable wrap security device in which the security device can be incorporated.

FIG. 7 is a diagrammatic perspective view of a cable loop attachment device containing the security device of the present invention.

Similar numbers refer to similar parts throughout the drawings.

### DETAILED DESCRIPTION OF THE INVENTION

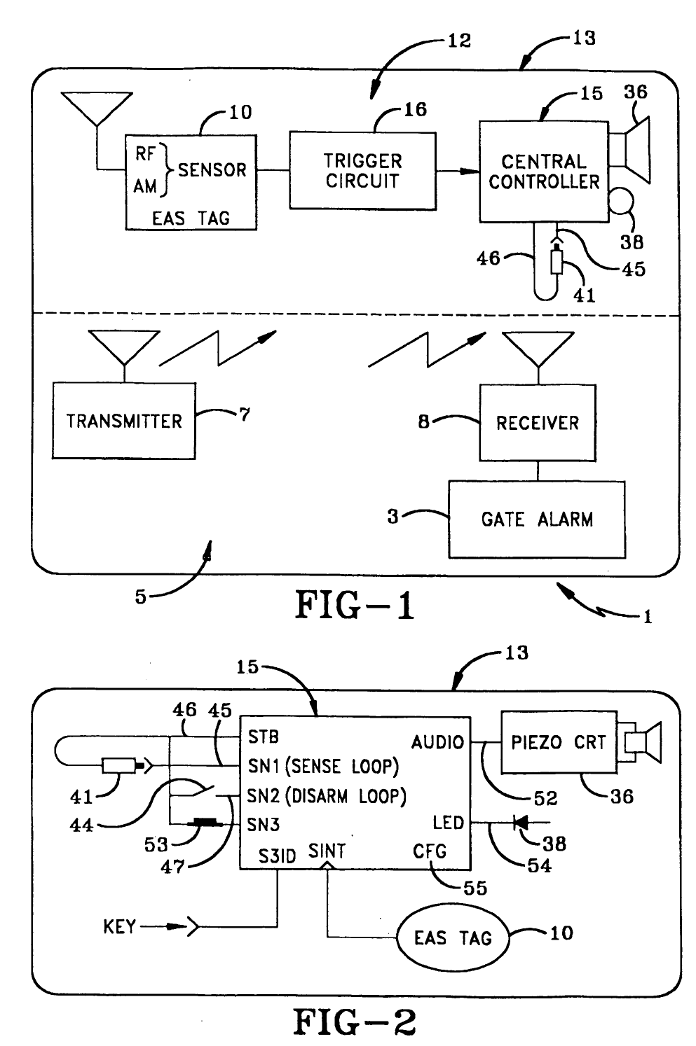

The improved security system of the present invention is indicated generally at 1, and is shown diagrammatically in FIG. 1. Security system 1 includes as its main component a gate alarm 3, which will be located in close proximity to a security gate indicated generally at 5, and shown in the bottom half of FIG. 1. The security gate will include a usual transmitter 7 and a receiver 8 for detecting an active EAS tag 10 upon it passing through the secured gate by use of radio frequency (RF) or magnetic sensitivity (AM), all of which are well known in the security field, and thus are not described in further detail.

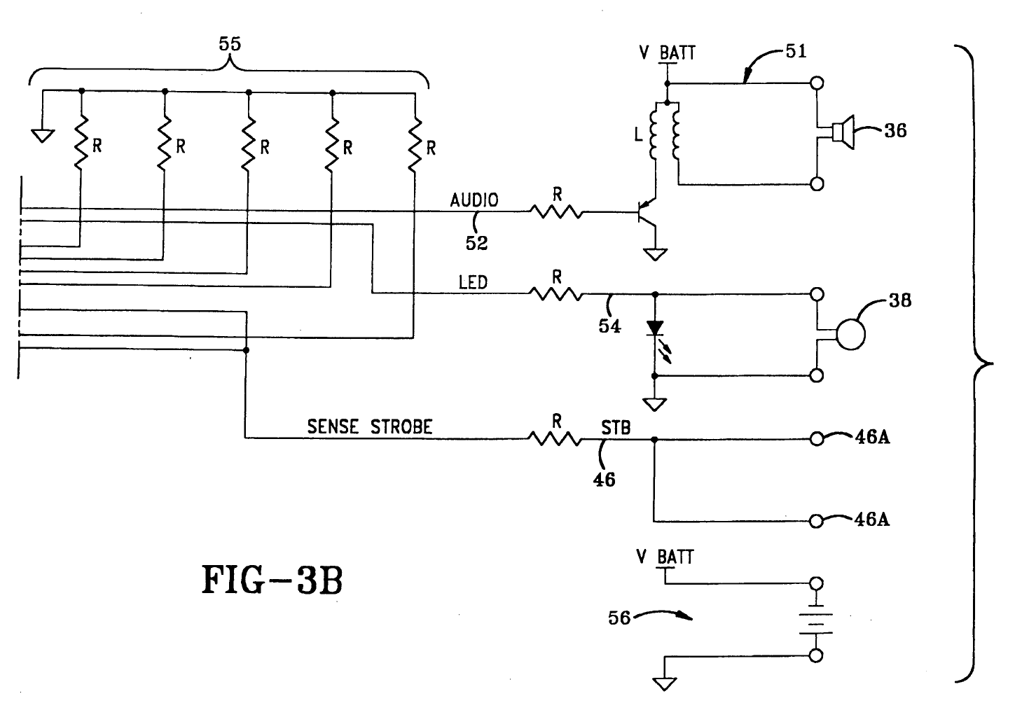

The security device of the present invention is indicated generally at 12, and is shown diagrammatically in the upper portion of FIG. 1 and in FIG. 2. Security device 12 includes a main circuit module indicated generally at 13 (FIG. 2), which includes a central controller 15, a trigger circuit 16, the RF or magnetic EAS tag 10. Security device 12 preferably is a solid state circuit board construction and will be placed within a protected housing and attached to various articles of merchandise, examples of which are shown in FIGS. 4-7. FIG. 4 diagrammatically represents a merchandise display assembly such as shown and described in pending U.S. patent application Ser. No. 10/939,069, filed Sep. 10, 2004. The security device when placed in such a display assembly, as shown in FIG. 4, will include various sense loops, one of which will extend through a cable 19 attached to an article of merchandise 21, for sounding an alarm as discussed further below. It may also contain another sense loop which will monitor an internal switch, such as a reed switch, to determine if it has been actuated such as by use of a key to unlock or deactivate the protected display assembly or other protected device.

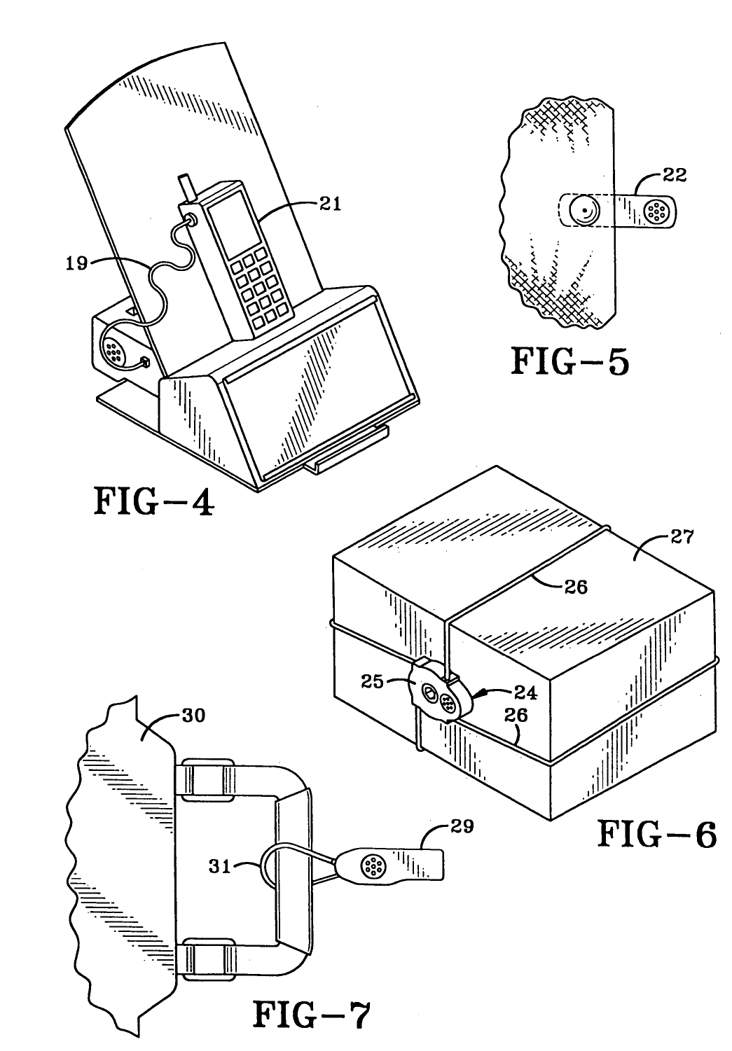

FIG. 5 diagrammatically represents a type of garment tag 22, which will contain an EAS tag and a sense loop, which if compromised, will sound an alarm in the security device. FIG. 6 shows a type of cable wrap security device indicated at 24, which includes a ratchet mechanism 25 and a plurality of cables 26 which encircle a generally rectangular-shaped article of merchandise 27. Again, cables 26 will provide a portion of the sense loop, which if compromised, will sound an alarm protected within ratchet mechanism 25. FIG. 7 shows still another type of security device such as a cable lock 29, which is secured to an article of merchandise 30 by a cable 31. The sense loop extends through cable 31 and will sound an alarm protected within cable lock 29 when broken, cut or compromised in some unauthorized manner. The four items of merchandise, and the particular shapes and forms of the security devices shown in FIGS. 4-7, are illustrative of four particular types of devices and their intended use. However, these are illustrative examples only and there are numerous other types of security devices in which the security device of the present invention can be utilized for incorporation into the security system of the present invention.

FIGS. 1 and 2 are diagrammatic block diagrams of portions of the security device which includes control module 13, which preferably is a printed circuit board. Module 13 contains the central controller 15, trigger circuit 16, and the EAS tag 10 being connected thereto, and in addition shows an audible alarm 36 and visual indication signal 38 connected thereto, and a sense loop 45, discussed further below.

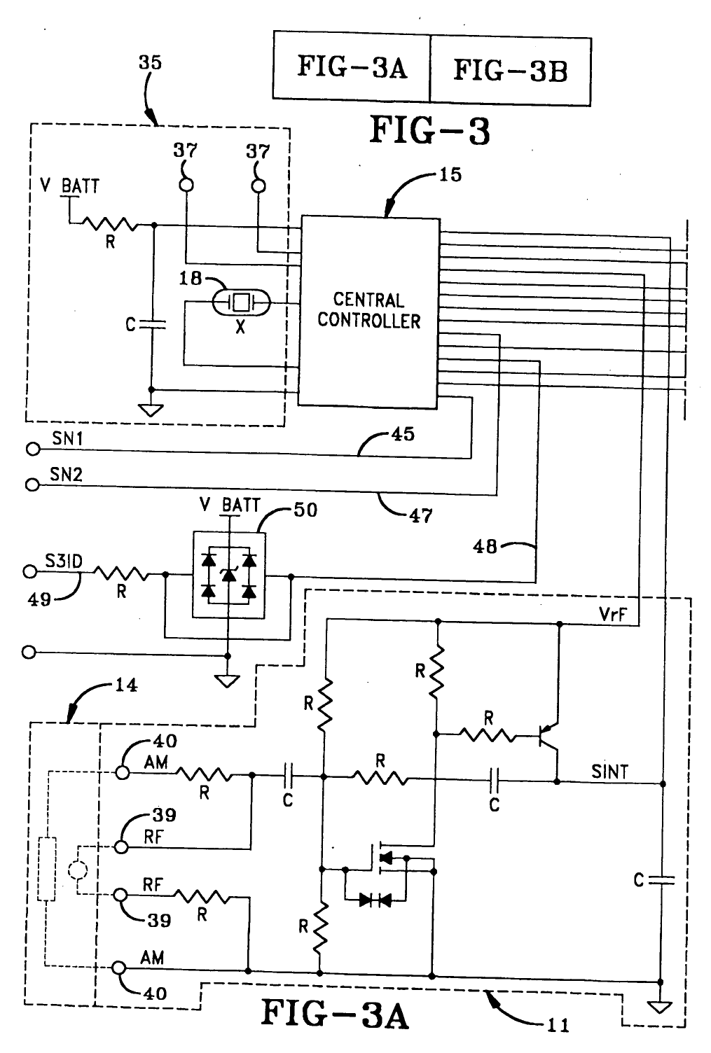

FIGS. 3A and 3B is the electrical schematic of one type of circuitry for control module 13 and the various components discussed above, which is utilized for achieving the effects of security system 1 and security device 12. The control module including central controller 15 preferably will be a solid state circuit board arrangement readily assembled and constructed by one skilled in the art for carrying out the desired objectives of the invention and controlling the other electronic components of the circuit module discussed further below, and thus is not described in further detail.

Trigger circuit 16 is shown in the dashed box 11 in the lower portion of FIG. 3A and includes the necessary resistors, capacitors and other electrical components for actuating an audible alarm 36 through central controller 15 upon EAS tag 10 which is operatively connected thereto, approaching the vicinity of security gate 5. EAS tag 10 is shown located within dashed block 14 adjacent trigger circuit 16, and will include connections for connecting the tag either to the RF ports 39 if a radio frequency (RF) type of EAS tag is used, or for connecting it to ports 40, if a magnetic sensitive EAS tag or coil is utilized (AM). Thus, either type of security sensor broadly referred to hereinafter as an EAS tag, can either be magnetically sensitive (AM) or radio (RF) sensitive and is easily incorporated into circuit module 13 by connecting the chosen security device (EAS) to ports 39 or 40 as shown by the dashed components within box 11.

The components in dashed block 35 (FIG. 3A) include two test terminals 37 to which various types of test equipment can be connected to test the integrity of circuit module 13 after manufacture and prior to installing it in a security device to ensure it is functioning correctly. A timing crystal 18 also is connected to central controller 15 and is shown in box 35.

Trigger circuit 16 is designed to work in conjunction with a security gate system external to security device 12 and in particular transmitter 7 thereof as shown in FIG. 1. The excitation level of trigger circuit 16 increases as the EAS tag contained in security device 12 approaches transmitter 7, and is adjusted by the selection and values of the various resistors and capacitors therein, to actuate alarm 36 when a specific level of excitation is reached. This correlates to a specific distance from the security gate, and is usually closer than the authorized checkout counter and areas of the retail store.

In accordance with one of the features of the invention, sense loop 45 (SN1) (FIG. 3A) is operationally connected to a sense strobe circuit 46. Sense loop 45 preferably is formed as part of an attachment loop such as cable 19 (FIG. 4), cable 26 (FIG. 6), cable 31 (FIG. 7) and is connected to sense strobe 46 (FIG. 2). When the integrity of the sense loop 45 is compromised, such as being cut or disconnected from the merchandise, it will cause central controller 15 to actuate audible alarm 36. Central controller 15 sends pulses out periodically through sense strobe 46 and sense loop 45 to ensure the sense loop is operating and that its integrity has not been compromised.

Another loop 47 (SN2) is operationally connected to sense strobe 46 and as discussed previously, is connected to an internal switch within the security device, which switch can be either normally open or normally closed, to determine the condition thereof. For example, switch 44 (FIG. 2) can be actuated when a magnetic release key is placed on the security device to disarm the alarming circuit or to physically open and unlock the security device to remove it from the protected merchandise. A pressure switch 41 may also be operationally connected to sense strobe 46 and physically connected to an article of merchandise to be protected thereby such as shown in the merchandise display assembly discussed above. This pressure switch will actuate alarm 36 if open or closed upon unauthorized removal of the merchandise from the security device. A pair of sense strobe connection ports 46A are provided on sense strobe circuit 46 for making the electrical connections to sense loop 45 and disarm loop 47.

A verification circuit 49 (S3ID) (FIG. 3A) is operationally connected to central controller 15 through a surge protector 50 by a conductor 48 and may be used to verify if a proper key, control card, input code or the like is authorized when being used to deactivate the sense loop and/or audible alarm when unlocking and removing the security device from an article of merchandise.

Audible alarm 36 preferably includes a piezo circuit indicated generally at 51, and connected to central controller 15 by conductor 52. Visual indicating light 38, such as an LED, is connected to central controller 15 through a conductor 54. Controller 15 preferably provides a blinking on/off effect to LED 38 to advise store personnel that the security device is activated and to warn a potential thief that the merchandise is protected by an active security device which may help deter shoplifting.

A group of resistors collectively referred to as 55 (FIG. 3B) and at CFG (FIG. 2), are provided to change and fine tune the various characteristics of the components discussed above for providing the desired results of the security device. The power source for the circuit module and other components of the security device is a self-contained battery indicated generally at 56, which will be attached to the printed circuit board of circuit module 13. Again, the particular components shown in the circuitry of FIG. 3 can vary without affecting the concept of the invention and are merely illustrative of one type of circuitry arrangement and components therefor which can be used to provide the results of the present invention.

In further accordance with the invention, the security device is contained within a secure housing and in particular, the control module, audible alarm, visual indicating light, and sensing components, such as shown in FIGS. 4-7, and is connected to an article of merchandise by some type of attachment mechanism such as cables 19, 26, and 31. As discussed above, these components can be connected to an internal mechanism which includes a circuit having a switch, such as switch 53 (FIG. 2), which is activated if part of the merchandise display is separated such as discussed in pending application Ser. No. 10/939,069, identified above, and shown in FIG. 4. In this type of device, a switch will be actuated if portions of the base are separated from each other. If the article of merchandise is removed from cable 19, pressure switch 41 will be actuated, and if cable 19 is severed, the continuity of sense loop 45 is interrupted, which is sensed through sense strobe 46 to actuate alarm 36.

Upon the integrity of the sense loop 45 being compromised, such as one of the cables being cut, removed from the protected merchandise, or pulled loose from the physical housing of the security device, such as ratchet 24 (FIG. 6) or cable lock 29 (FIG. 7), the central controller will actuate audio alarm 36, which is concealed and protected within a particular housing of the security device. Alarm 36 will immediately alert store personnel that an attempted shoplifting is in progress. Alarm 36 will continue to sound for a predetermined period of time, for example ten minutes, unless deactivated by store personnel. This increases the difficulty of the thief concealing the merchandise even after leaving the store from which the merchandise was stolen. Thus, the alarm will continue to sound as he/she escapes into an adjacent parking lot, street, etc.

In further accordance with the invention, security device 12 and security system 1 provides the additional feature as discussed above, of activating internal alarm 36 should the security device reach a certain vicinity adjacent the remote security gate 5. Thus, should a shoplifter attempt to steal an article of merchandise having the security device attached thereto without compromising the integrity of any of the sense loops, the audible alarm will still sound and remain audible for a specific period of time upon the shoplifter even approaching the security gate due to the RF or AM sensor, and trigger circuit 16 through central controller 15, actuating alarm 36. Also, upon the shoplifted merchandise passing through the security gate, self-contained EAS tag 10 will actuate the security gate alarm 3. This provides an additional security feature since at certain times, the security gate system may not be activated to sound its alarm due to the reduced sensitivity thereof but security device 12 would actuate internal alarm 36 that would remain audible on the stolen merchandise as it is removed from the premises, alerting personnel in the parking lot, adjacent streets, etc. that the item has been stolen since the alarm is still sounding.

Thus, the improved security system of the present invention provides for the sounding of an alarm should the security device be removed in an unauthorized manner from the protected article of merchandise, will sound a security gate alarm upon passing through the gate, and in addition, will sound the alarm contained in the security device upon reaching a predetermined distance from the security gate, providing an alarm even though the security device has not been removed from the protected merchandise.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A security device for articles of merchandise comprising:
an attachment mechanism for securing the security device to the article of merchandise;
a sense loop for monitoring a condition of the security device; a central controller which monitors the integrity of the sense loop;
a power source for powering the central controller;
an audible alarm carried by the security device actuated by the central controller when the integrity of the sense loop is compromised;
a security gate sensor for actuating the audible alarm of the security device upon the security device being in proximity to a security gate; and
an EAS tag carried by the security device for actuating a security gate alarm when detected by said security gate.

2. The security device defined in claim 1 wherein the power source is a battery contained within the security device.

3. The security device defined in claim 1 wherein the EAS tag is Radio Frequency (RF) sensitive or magnetically sensitive (AM).

4. The security device defined in claim 1 wherein the audible alarm includes a piezo actuated circuit.

5. The security device defined in claim 1 including a visual signal indicating a condition of the security device.

6. The security device defined in claim 5 wherein the visual signal is an LED.

7. The security device defined in claim 1 including a trigger circuit which cooperates with the sense loop and central controller to activate the audible alarm when the integrity of the sense loop is compromised.

8. The security device defined in claim 1 wherein the attachment mechanism includes a lock device for locking the security device to the article of merchandise and a key for unlocking the locking device, said key containing a code monitored by the central controller.

9. A security system for protecting merchandise comprising:
a security gate having a sensor for detecting an EAS tag passing through the gate;
a security device for attaching to an article of merchandise, said device including the EAS tag, a sense loop, an audio alarm and a controller, said controller monitoring the integrity of the sense loop and if interrupted, activates the audio alarm of the security device;
wherein the controller activates the security device alarm upon the security device being in proximity to the security gate; and
wherein the security gate sensor activates a second audio alarm remote from the security device upon detecting the EAS tag in the security device.

10. The security system defined in claim 9 wherein the central controller is a microprocessor.

11. The security system defined in claim 9 wherein the circuit module includes a central controller and a trigger circuit, said trigger circuit actuating the audible alarm of the security device if the sense loop is interrupted.

12. The security system defined in claim 11 wherein the security device contains a battery for powering the circuit module.

13. The security system defined in claim 10 wherein the circuit module maintains the audible alarm of the security device once activated, for a predetermined time period, unless deactivated by authorized personnel.

14. The security system defined in claim 10 wherein the EAS tag is Radio Frequency (RF) sensitive or magnetically sensitive.

15. The security system defined in clam 10 wherein the security device includes a visual signal indicating the condition of the security device.

16. A circuit module for incorporation in a security device for protecting articles, said circuit module comprising:
a central controller which monitors the integrity of a sense loop which is part of a wired connection for attaching the security device to the article,
an audible alarm which is actuated by the central controller when (1) the integrity of the sense loop is compromised and (2) when the security device is detected by a remote security gate; and
an EAS tag operatively connected to the central controller for actuating a security gate alarm when detected by said security gate.

17. The circuit module defined in claim 16 wherein the central controller is powered by a battery.

18. The circuit module defined in claim 16 wherein the central controller includes a visual signal which indicates a condition of the security device.

19. The circuit module defined in claim 18 wherein the visual signal is a flashing LED.

20. The circuit module defined in claim 16 wherein the central controller maintains the audible alarm actuated for a predetermined time period once actuated by either of the two conditions set forth in claim 16.
